(19) United States
(12) Patent Application Publication
(10) Pub. No.: US 2011/0162731 A1
(43) Pub. Date: Jul. 7, 2011

(54) Micro-regulator device

(76) Inventor: Paul Califano, Cairo, GA (US)

(21) Appl. No.: 12/658,521

(22) Filed: Feb. 11, 2010

Related U.S. Application Data
(60) Provisional application No. 61/335,260, filed on Jan. 4, 2010.

(51) Int. Cl. G05D 16/00

(52) U.S. Cl. 137/505; 137/505.18

(57) ABSTRACT

A regulator comprised of a housing having an ingress for connection to a source of gas at a first pressure and an egress adapted for supplying gas at a lower pressure than the first pressure. A fixed member, located within the housing, separates the ingress from the egress and has at least one opening extending therethrough. A throttling tube is located in the housing and extends through the opening in the fixed member to control the flow of gas from the ingress to the egress. The throttling tube has a first end juxtaposed with a compressible disk and a second end juxtaposed with a valve seat. An actuation lever responds to a pressure within the housing to move the throttling tube into and out of engagement with the valve seat. The throttling tube responds to a force provided by the disk when it is out of engagement with valve seat.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of regulator devices for compressed gas. Specifically, this invention relates to a regulator device which controls the flow of compressed gas from the high-pressure side to the application side of the device.

2. Description of the Related Art

One and two stage high-pressure regulators are used in a wide variety of applications to control the flow of compressed gas from the high-pressure side to the application side in a manner that provides gas pressures suitable for the appropriate use at the application side of the regulator. Various industries with applications requiring two stage high pressure breathable air regulators include scuba applications, medical oxygen therapy, emergency medical services, fire fighting, environmental hazard response, search and air rescue, among others. In all of those applications, the purpose of the regulator is to take a high-pressure, breathable, gas source, e.g. an air cylinder, and deliver the air or other gas to the user at a pressure equal to ambient pressure. To accomplish that, the gas must pass through two pressure reduction stages. In current practice, the first stage is typically attached to the cylinder source valve. The first stage takes incoming high pressure gas from the cylinder and reduces it to an intermediate pressure of approximately 130 psi over ambient. The second stage, which fits into the user's mouth, receives the intermediate pressure from the first stage and reduces it to ambient pressure. The high-pressure cylinder source can vary in pressure depending on the application. For example, many diving applications use pressure tanks pressurized to 6000 psi whereas medical oxygen therapy pressure tanks carry compressed oxygen at 3000 psi.

There are numerous problems associated with the prior art, depending upon the particular application. For example, in scuba applications, the extreme cold encountered at deep diving depths may cause the pressure regulators to freeze up and malfunction. A common problem across all regulator applications is the use of mechanical springs to supply a force for either urging a valve into an open position or a closed position. Because regulators must be balanced to provide gas at a relatively stable psi, the springs must be precisely calibrated (shimmed) to insure that the proper force is being applied. Over time, because of the mechanical degradation of the springs, the force begins to change, which requires recalibrating of the regulator. Additionally, mechanical springs may be contaminated with debris, corrode, rust, or otherwise come in contact with material which changes the force supplied by the spring, again causing a malfunction necessitating recalibration. In extreme circumstances, failure of the spring may result in the regulator failing in an opened or closed position depending upon whether the valve in the regulator is a normally opened or normally closed valve. Such failures, depending upon the circumstances, may be catastrophic. Thus, the need exists for a regulator that overcomes the problems inherent in the prior art.

### BRIEF SUMMARY OF THE INVENTION

According to one embodiment of the present disclosure, a spring-less regulator is comprised of a housing having an ingress adapted for connection to a source of gas at a first pressure and an egress adapted for supplying gas at a lower pressure than the first pressure. A fixed member, located within the housing, separates the ingress from the egress. The fixed member has at least one opening extending there through. A compressible material is carried within the housing. A valve is located within the housing to control the flow of gas from the ingress to the egress. The valve is responsive to the compressible material such that the compressible material provides a force on the valve when the valve is in one of either an open position or a closed position

According to another embodiment of the present disclosure, a springless regulator is comprised of a housing having an ingress adapted for connection to a source of gas at a first pressure and an egress adapted for supplying gas at a lower pressure than the first pressure. A fixed member, located within the housing, separates the ingress from the egress. The fixed member has at least one opening extending there through. A compressible material is carried at one end of the housing. A valve seat is carried at an end of the housing opposite from the end carrying the compressible material. A throttling tube is located in the housing and extends through the opening in the fixed member to control the flow of gas from the ingress to the egress. The throttling tube has a first end juxtaposed with the compressible material and a second end juxtaposed with valve seat. An actuation lever is responsive to a pressure within the housing to move the throttling tube into and out of engagement with the valve seat. The throttling tube is responsive to a force provided by the compressible material when the throttling tube is out of engagement with valve seat.

According to yet another embodiment of the present disclosure, a springless regulator is comprised of a housing having an ingress adapted for connection to a source of gas at a first pressure and an egress adapted for supplying gas at a lower pressure than the first pressure. A fixed member, located within the housing, separates the ingress from the egress. The fixed member has at least one opening extending there through. A compressible material is carried at one end of the housing and has an opening extending there through. A throttling tube extends through the ingress and the opening in the compressible material. A piston is positioned between the fixed member and the compressible material to control the flow of gas from the ingress to the egress. The piston has a first face carrying a seat. The piston is adapted for moving the seat into and out of engagement with the throttling tube. The compressible material is carried so as to be compressed when the seat engages the throttling tube.

The regulators of the present disclosure may be used to construct a multistage regulator. For example, a multistage, springless regulator may be comprised of a housing having an ingress adapted for connection to a source of gas at a first pressure and an egress adapted for supplying gas at a lower pressure than the first pressure. A first fixed member, located within the housing, separates the ingress from an intermediate chamber. A second fixed member, located within the housing, separates the intermediate chamber from the egress. The fixed members each have at least one opening extending there through. A first valve is located within the housing to control the flow of gas from the ingress to the intermediate chamber and a second valve located within the housing to control the flow of gas from the intermediate chamber to the egress. A compressible material is located within the housing such that at least one of the first and second valves is responsive to a force exerted by the compressible material when in one of either an open position or a closed position.

In any of the embodiments, the compressible member may be color coded to provide an indication of the force provided by the member to aid in assembly or repair operations. The compressible member replaces the springs found in prior art regulators thereby eliminating the problems associated with such mechanical components. Those advantages and benefits, and others, will become apparent from the description set forth below.

### BRIEF DESCRIPTION OF THE SEVERAL VIEWS OF THE DRAWINGS

For the present invention to be easily understood and readily practiced, the present invention will now be described, for purposes of illustration and not limitation, in conjunction with the following figures, wherein:

FIG. 1A is a cross-sectional view of a regulator constructed according to the teachings of the present disclosure;

FIG. 1B illustrates a piston carrying a valve seat for interfacing with the downstream end of the throttling tube shown in FIG. 1A;

FIG. 2A is a cross-sectional view of another embodiment of a regulator constructed according to the teachings of the present disclosure;

FIG. 2B illustrates a valve seat carried by a housing for interfacing with the upstream end of the throttling tube shown in FIG. 2A;

FIG. 2C is a detailed view of the downstream end of the throttling tube of FIG. 2A interfacing with a compressible material;

FIG. 3 is a detailed view of the compressible material of FIG. 2C;

FIG. 4 illustrates a pressure sensitive value actuation lever;

FIG. 5A is a perspective view of a multistage regulator constructed according to the teachings of the preset disclosure suitable for use in a scuba application;

FIG. 5B is an end view of a multistage regulator constructed according to the teachings of the preset disclosure suitable for use in a scuba application;

FIG. 6 is a cross-section view taken along the lines VI-VI in FIG. 5B; and

FIG. 7 is an exploded view of the multistage regulator of FIGS. 5 and 6.

REFERENCE NUMERALS IN THE DRAWINGS

| | | | |
|---|---|---|---|
| 10 | regulator | 11 | housing |
| 12 | cylindrical center portion | 14 | upstream end cap |
| 16 | downstream end cap | 18 | ingress |
| 20 | egress | 22 | fixed member |
| 24 | plurality of openings | 26 | compressible material |
| 28 | opening | 30 | downstream end of throttling tube |
| 32 | piston | 34 | first face |
| 36 | seat | 38 | concaved second face |
| 40 | channels | 42 | downstream chamber |
| 44 | chip | 46 | center |
| 48 | radial portion | 49 | perimeter portion |
| 50 | regulator | 51 | housing |
| 52 | cylindrical upstream portion | 53 | cylindrical downstream portion |
| 54 | upstream end cap | 56 | downstream end cap |
| 58 | ingress opening | 60 | egress opening |
| 62 | fixed member | 64 | opening |
| 66 | compressible material | 68 | valve seat |
| 70 | throttling tube | 72 | downstream end |
| 74 | upstream end | 76 | openings |
| 78 | O-ring | 80 | sliding member |
| 82 | circular opening | 84 | O-ring |
| 86 | actuation lever | 90 | multistage regulator |
| 91 | chamber | 92 | mouthpiece housing |
| 94 | exhaust cap | 96 | valve |
| 100 | housing | 102 | upstream portion |
| 104 | intermediate portion | 106 | downstream portion |
| 110 | first stage regulator | 114 | upstream end cap |
| 118 | ingress opening | 122 | first fixed member |
| 124 | openings | 126 | compressible member |
| 130 | first stage throttling tube | 132 | piston |
| 134 | first face | 136 | seat |
| 138 | second face | 140 | channels |
| 142 | downstream chamber | 150 | second stage regulator |
| 156 | downstream end cap | 160 | egress opening |
| 162 | second fixed member | 164 | opening |
| 166 | disk | 168 | valve seat |
| 170 | second stage throttling tube | 172 | downstream end |
| 174 | upstream end | 176 | openings |
| 178 | O-ring | 180 | sliding member |
| 182 | opening | 184 | O-ring |
| 186 | actuation lever | 190 | hose connector |
| 192 | hose crimp sleeve | 194 | retaining nut |
| 196 | high-pressure hose | 198 | sleeve fitting |

### DETAILED DESCRIPTION OF THE INVENTION

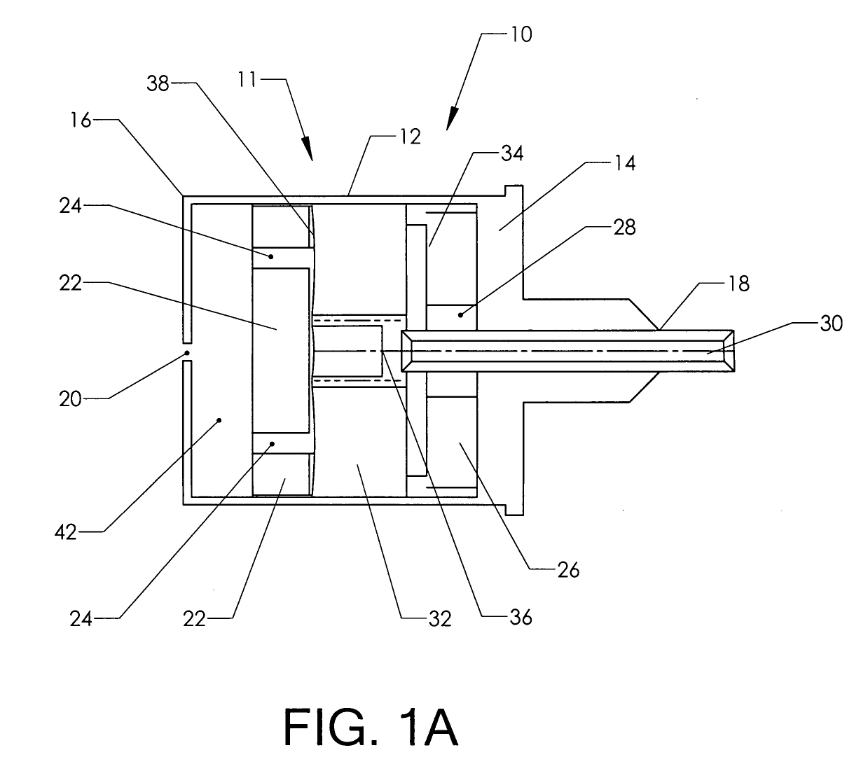

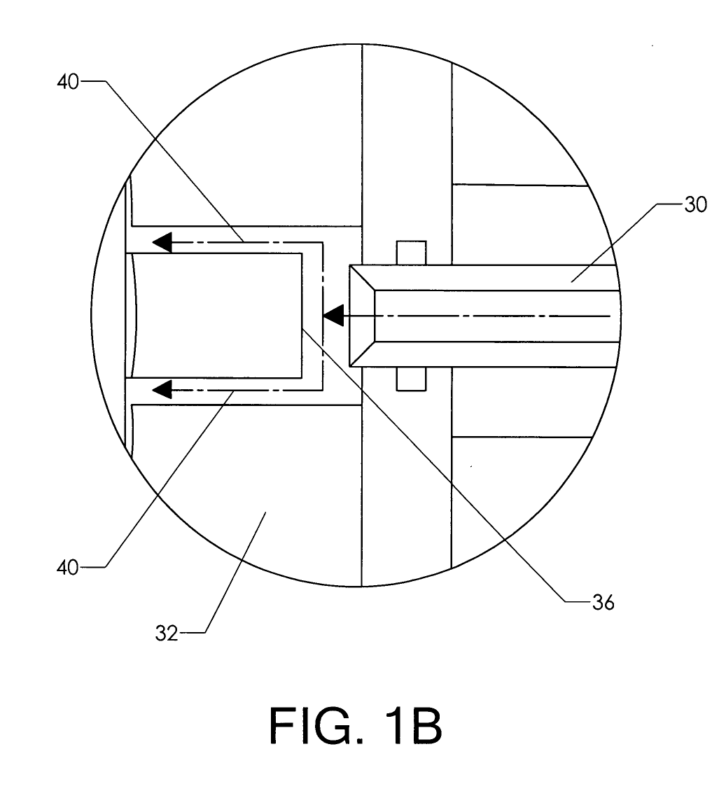

FIG. 1A is a cross-sectional view of a regulator 10 constructed according to the teachings of the present disclosure. Regulator 10 is comprised of housing 11 constructed, for example, of a cylindrical center portion 12, a first or upstream end cap 14 and a second or downstream end cap 16. Upstream end cap 14 has an ingress opening 18 adapted for connection to a source of gas (not shown) at a first pressure. Downstream end cap 16 has an egress opening 20 adapted for supplying gas at a lower pressure than the pressure of the source of gas. A fixed member 22 is located within the housing and separates ingress 18 from egress 20. Fixed members has at least one, and preferably a plurality of openings 24 extending there through. A washer-shaped disk of compressible material 26 is carried at one end of the housing. In this embodiment, compressible material 26 is carried at the end of the housing so as to be located adjacent to upstream end cap 14. Compressible material 26 has an opening 28 extending there through. A throttling tube 30 extends through ingress opening 18 in upstream end cap 14 and also extends through opening 28 in compressible material 26.

A valve is located within housing 11 in a manner to be responsive to compressible material 26 such that compressible material 26 provides a force on the valve when the valve is in one of either an opened or closed position. In the embodiment shown in FIG. 1A, the valve takes the form of a piston 32 positioned between fixed member 22 and compressible material 26 to control the flow of gas from ingress 18 to egress 20. Piston 32 has a first face 34 carrying a seat 36, seen best in FIG. 1B. Piston 32 has a second, concaved face 38 juxtaposed with fixed member 22. Piston 32 is adapted for moving left to right in FIG. 1A between fixed member 22 and compressible material 26.

The downstream end of throttling tube 30 has a raised sharp edge sometimes referred to as a crown, cone, or hard seat. As piston 32 moves to the right, seat 36 engages the downstream end of throttling tube 30 to shut off the flow from the source of gas. When piston 32 has moved to the right of the position as shown in FIG. 1A, to assume an upstream position, valve seat 36 engages the downstream end of throttling tube 30 and simultaneously compresses compressible material 26. Thus, when piston 32 is in the upstream position, compressible material 26 exerts a force on piston 32 urging piston 32 to the left, into a downstream position.

The concaved second face 38 of piston 32 is in communication with seat 36 through a plurality of channels 40, best seen in FIG. 1B. Egress opening 20 is in communication with a downstream chamber 42. Downstream chamber 42 receives gas through openings 24 in fixed member 22.

In operation, the valve of the regulator will be open as shown in FIG. 1A allowing gas from the source of gas to pass through throttling tube 30, channels 40 in piston 32 to the concaved second face 38 of piston 32. The gas then travels through openings 24 in fixed member 22 to downstream chamber 42. A valve, gate, or user's mouth (not shown) may be positioned at egress 20 so that pressure may be built up in downstream chamber 42. Because the pressure in downstream chamber 42 acts upon the entire concaved second face 38 of piston 32, compared to the pressure in throttling tube 30 which acts only upon the small area of seat 36, it is possible for the pressure in downstream chamber 42 to build to a point, substantially less than the pressure of the gas at the source of gas, so as to move piston 32 from the downstream position illustrated in FIG. 1A, to its upstream position (not shown). When in the upstream position, the downstream end of throttling tube 30 is closed off by seat 36 and compressible material 26 is compressed. Thus, at this time, a relationship is established at which the pressure in downstream chamber 42, times the surface area of the concaved second face 38 of piston 32, is slightly greater than the pressure of the source of gas multiplied by the area of seat 36, plus the force exerted by compressible material 26. Should any pressure be released from downstream chamber 42, such as demand needed for the application, the piston will move from its upstream position to its downstream position, and remain in the downstream position until the aforementioned relationship is re-established. When the relationship is re-established, piston 32 will again assume its upstream position.

Those of ordinary skill in the art will recognize that by knowing the source gas pressure, selecting the surface area of the concaved second face 38 of piston 32, selecting the diameter of throttling tube 30 and by selecting an appropriate compressive material 26 such that it exerts a known force, the aforementioned relationship can be established at various pressures; i.e. the pressure in chamber 42 and hence the application pressure can be set.

In one embodiment, compressible material 26 can be provided so as to change the set point at which regulator 10 operates. The compressible material 26 may be colored coded to identify the pressure exerted by the disk, and hence the operating point of regulator 10, for ease of construction and maintenance. Because housing 11 is comprised of three portions, housing 11, together with fixed member 22, may be press fit and/or welded to eliminate the need for threading small components.

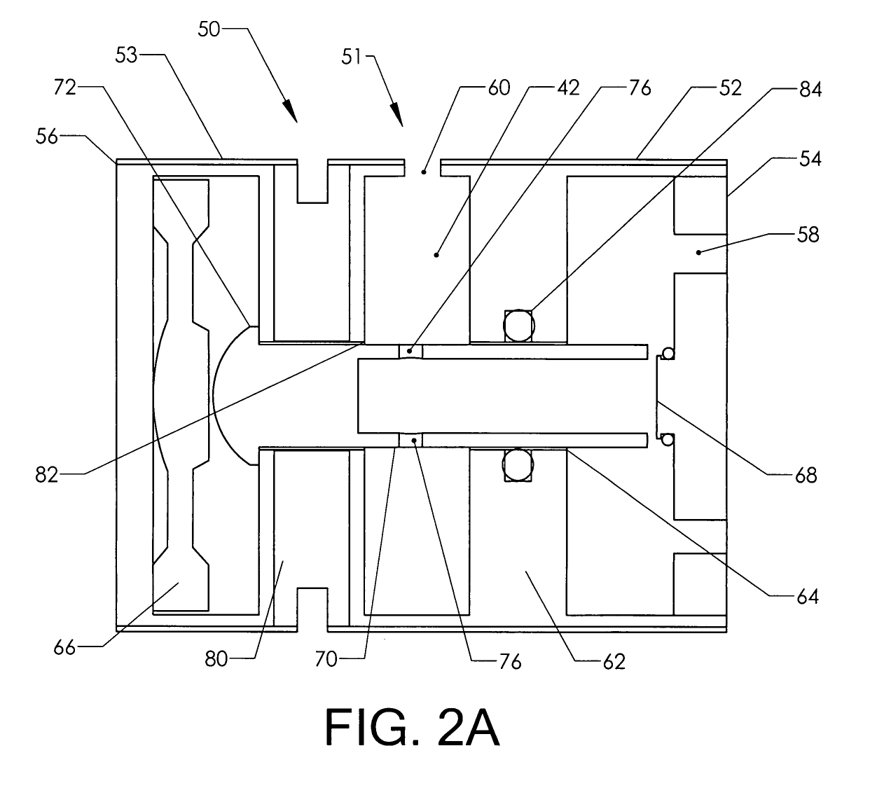

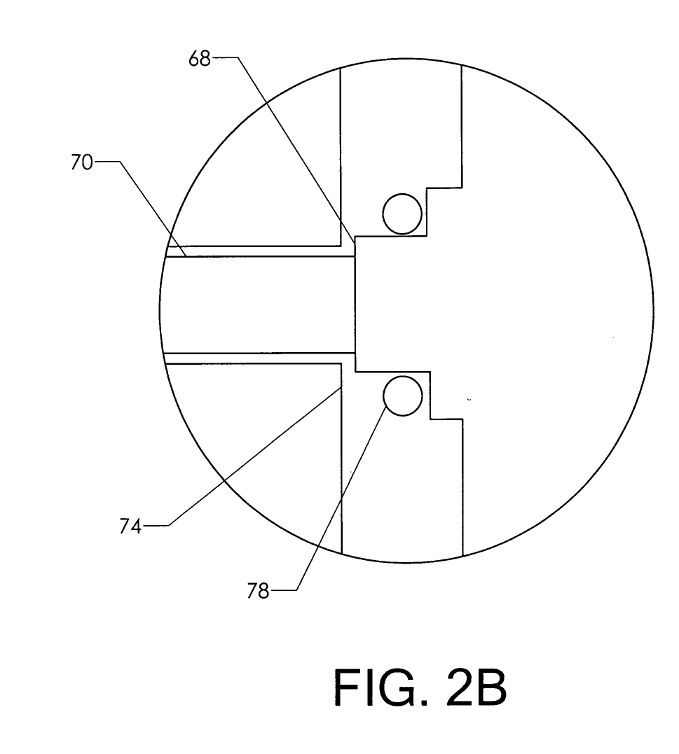

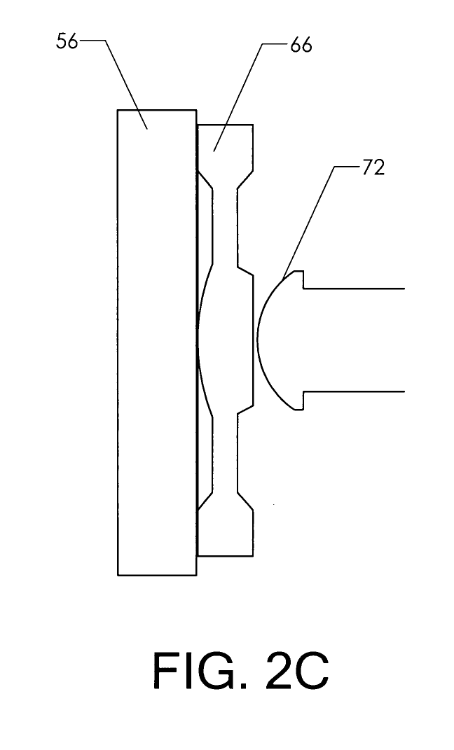

The embodiment illustrated in FIGS. 1A and 1B is exemplary only. Those of ordinary skill in the art will recognize that many modifications and variations are possible. For example, just about anything that a regulator does can be done in either of two ways. The valve can be constructed so that the source gas pressure will try to push it closed, or it may be constructed such that the source of gas pressure will try to push it open as in FIG. 1A. The valve can be normally open, in which case the force exerted by compressive material 26 will hold the valve open as in FIG. 1A, and the pressure in chamber 42 will force the valve to close, or the valve can be normally closed in which case the force exerted by compressive material 26 will hold the valve shut and the pressure in chamber 42 will cause it to open. The valve can consist of a fixed orifice (e.g., the downstream end of throttling tube 30) and a moving seat as shown in FIG. 1A or the valve may consist of a fixed seat and a moving orifice. Such implementation details do not affect the teachings of the present disclosure which is intended to cover embodiments incorporating all such variations. To illustrate that principle, another embodiment of a regulator constructed according to the teachings of the present disclosure is discussed in conjunction with FIGS. 2A-2C, FIG. 3 and FIG. 4.

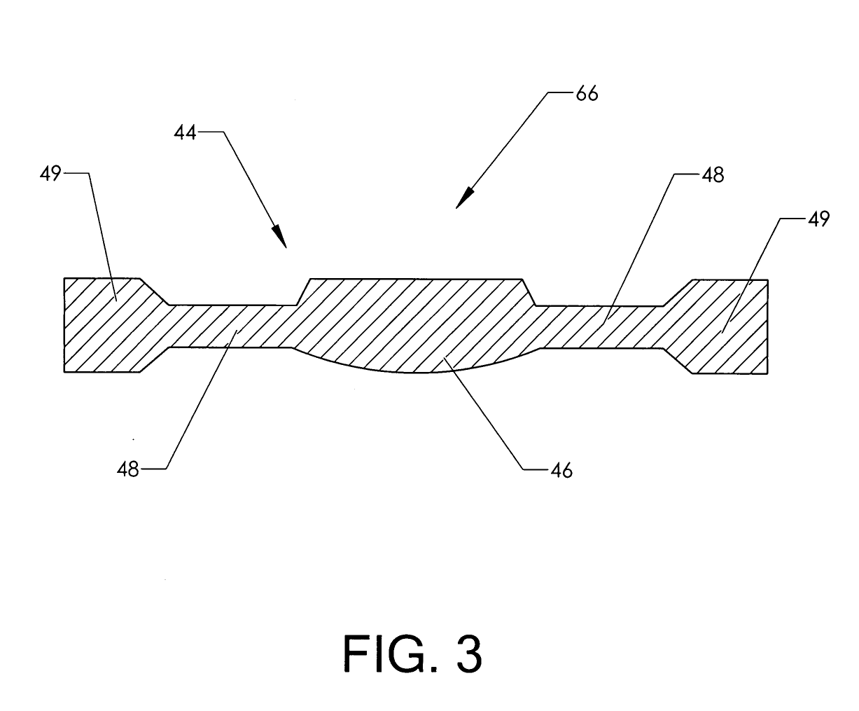

Turning first to FIG. 2A, a regulator 50 is comprised of a housing 51 constructed, for example, of a cylindrical upstream portion 52, a cylindrical downstream portion 53, a first or upstream end cap 54 and a second or downstream end cap 56. Upstream end cap 54 has an ingress opening 58 adapted for connection to a source of gas (not shown) at a first pressure. The downstream portion 53 of housing 51 has an egress opening 60 adapted for supplying gas at a lower pressure than the pressure of the source gas. A fixed member 62 is located within housing 51 and separates ingress 58 from egress 60. Fixed member 62 has an opening 64 extending there through. A compressible material 66 is carried at one end of the housing and formed into a chip 44, preferably made up of urethane foam (shown in FIG. 3). In the embodiment shown in FIG. 2A, compressible material 66 is carried at the end of housing 51 so as to be adjacent to downstream end cap 56. Valve seat 68 is carried at an end of housing 51 opposite from the end carrying compressible material 66. Thus, in the embodiment shown in FIG. 2A, upstream end cap 54 may have valve seat 68 formed therein. Valve seat 68 is seen best in FIG. 2B.

A throttling tube 70 is carried in the housing so as to extend through opening 64 in fixed member 62 to control the flow of gas from ingress 58 to egress 60. Throttling tube 70 has a downstream end 72 juxtaposed with compressible material 66, as seen best in FIG. 2C, and an upstream end 74 positioned so as to interact with valve seat 68 as seen best in FIG. 2B. Throttling tube 70 may have openings 76 formed therein which lead to downstream chamber 42. The upstream end 74 of throttling tube 70 is seen in greater detail in FIG. 2B interfacing with valve seat 68. Valve seat 68 may carry an O-ring 78 to seal off the upstream end 74 of throttling tube 70 from the source of high-pressure gas available at ingress 58.

Downstream end 72 of throttling tube 70 is shown in greater detail in FIG. 2C interacting with compressible material 66 held in place by downstream end cap 56. FIG. 3 is a detail cross-section of compressible material 66 formed into chip 44. Chip 44 is a circular disk preferably made up of urethane foam, however, chip 44 could also be made up of elastomeric material or other material with similar compressible characteristics. The unique shape of chip 44 is important to provide the required resistance to throttling tube 70, as shown in FIG. 2A. Chip 44 has a center 46 which is a plano-convex shape, having a flat side which sits flush with the convex end of throttling tube 70 and a convex side which interacts with downstream end cap 56. Radial portion 48 extends from center 46 of chip 44 and is narrower in its cross section than center 46 and allows for flexibility and resilience in center 46 of chip 44. Perimeter portion 49 is as thick as center 46 and provides a brace such that chip 44 is adequately held in place during operation of regulator 50.

Completing the description of regulator 50 shown in FIG. 2A, a sliding member 80 is circular in shape so as to be held within the housing. Sliding member 80 has a circular opening 82 there through for carrying downstream end 72 of throttling tube 70. The upstream end 74 of throttling tube 70 is carried within opening 64 in fixed member 62. A seal is formed between fixed member 62 and throttling tube 70 by an O-ring 84.

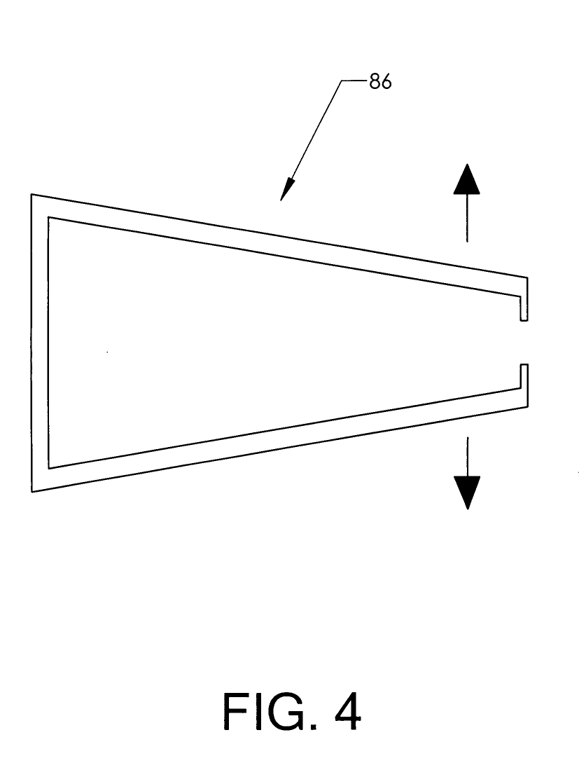

Sliding member 80 is responsive to an actuation lever 86, one example of which is illustrated in FIG. 4. Actuation lever 86 is responsive to a pressure within the housing, for example, the pressure within downstream chamber 42, to move the throttling tube horizontally, as shown in FIG. 2A, into and out of engagement with valve seat 68.

In operation, when demand is made for gas within downstream chamber 42, actuation lever 86 responds by having its upper and lower legs, as seen in FIG. 4, move up and down, respectively. The legs are in contact with fixed member 62 such that movement of the legs up and down, respectively, forces the vertical portion, as seen in FIG. 4, to the left. Movement to the left forces sliding member 80 and throttling tube 70 to the left as well. Movement to throttling tube 70 to the left as shown in FIG. 2A, to assume a downstream position, causes the upstream end 74 of throttling tube 70 to disengage from valve seat 68 and causes downstream end 74 of throttling tube 70 to compress compressible material 66. In this position, gas from the source of gas flows through ingress 58, past valve seat 68 into throttling tube 70, through openings 76 in throttling tube 70, and into downstream chamber 42, which may be controlled by, for example, a valve, a gate, or a user breathing on the device (not shown). When the pressure in downstream chamber 42 reaches the actuation pressure of actuation lever 86, actuation lever 86 returns to the orientation shown in FIG. 4. In doing so, throttling tube 70 moves to the right to assume its upstream position as shown in FIG. A in which compressible material 66 is not compressed, and the upstream end 74 of throttling tube 70 seats on valve seat 68 to stop the flow of air from ingress 58 into throttling tube 70. Thus, by proper selection of the material and construction of the actuation lever 86, in combination with the force exerted by compressible member 66, the pressure in chamber 42 and hence the application pressure can be set.

As with the first embodiment, compressible material 66 may be comprised of urethane foam, elastomeric material or specifically, EPDM rubber (ethylene propylene diene rubber). Furthermore, once regulator 50 has been designed, various washer-shaped disks of material 66 (disk 44) can be provided so as to change the set point at which regulator 50 operates. Compressible material 66 may be color coded to identify the pressure exerted by the disk, and hence the operating point of regulator 50, for ease of construction and maintenance. Because housing 51 is constructed of an upstream portion 52 and a downstream portion 53, and fixed member 62 is positioned there between, the upstream portion 52, downstream portion 53, fixed member 62, together with upstream end cap 54 and downstream end cap 56 may be press fit and/or welded to eliminate the need for threading small components.

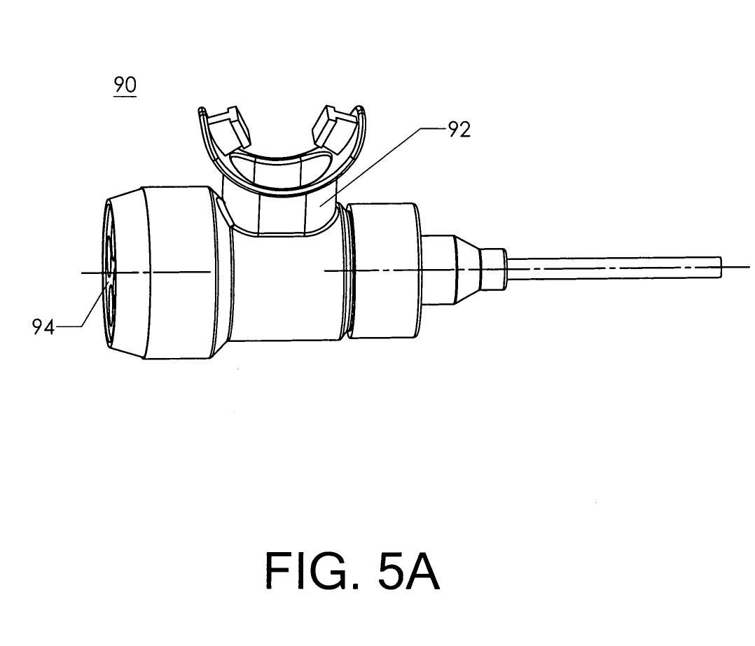

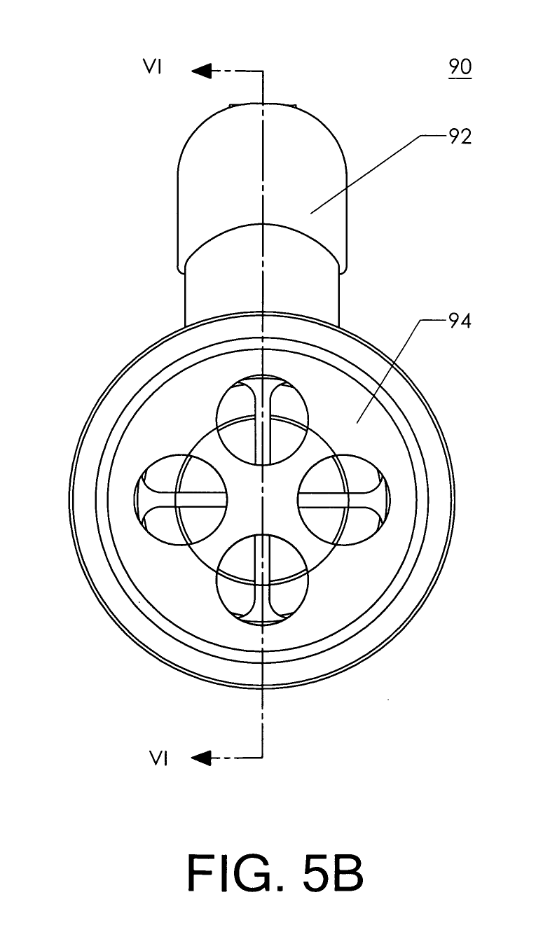

The teachings of the present invention may be used to construct single stage regulators as discussed above of various configurations and operation. Furthermore, the single stage regulators discussed herein may be used to construct a multistage regulator as will now be described in conjunction with FIGS. 5, 6, and 7. Although the embodiment disclosed in connection with FIGS. 5-7 is intended for scuba application, many other applications of multi-stage regulators constructed according to the teachings of the present invention may be constructed as will be described hereinafter.

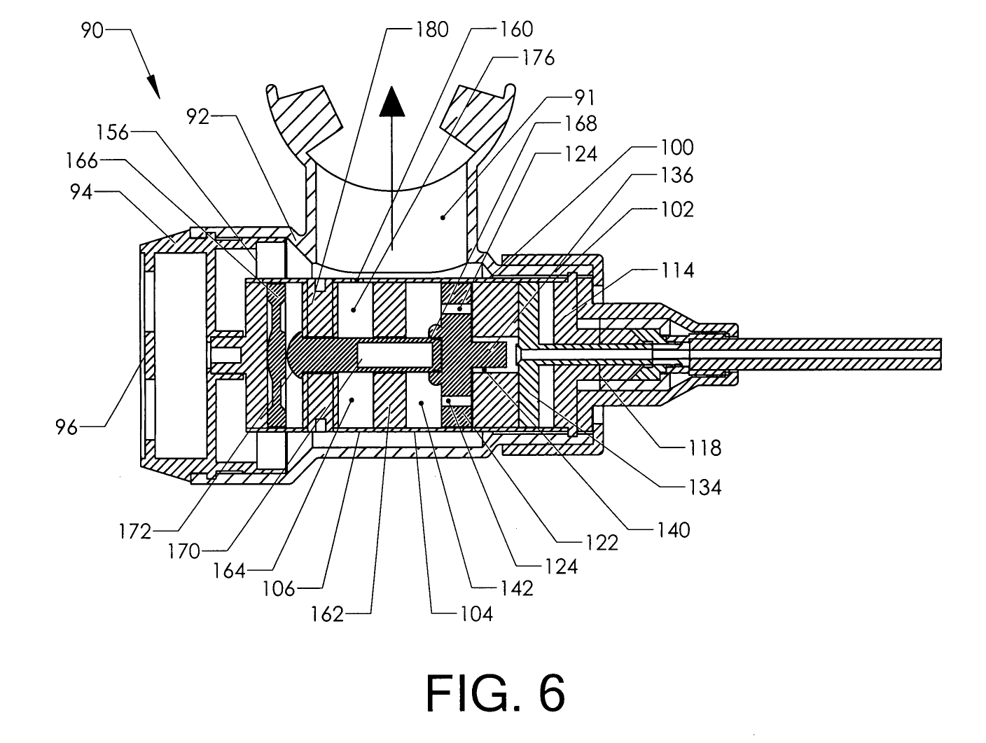

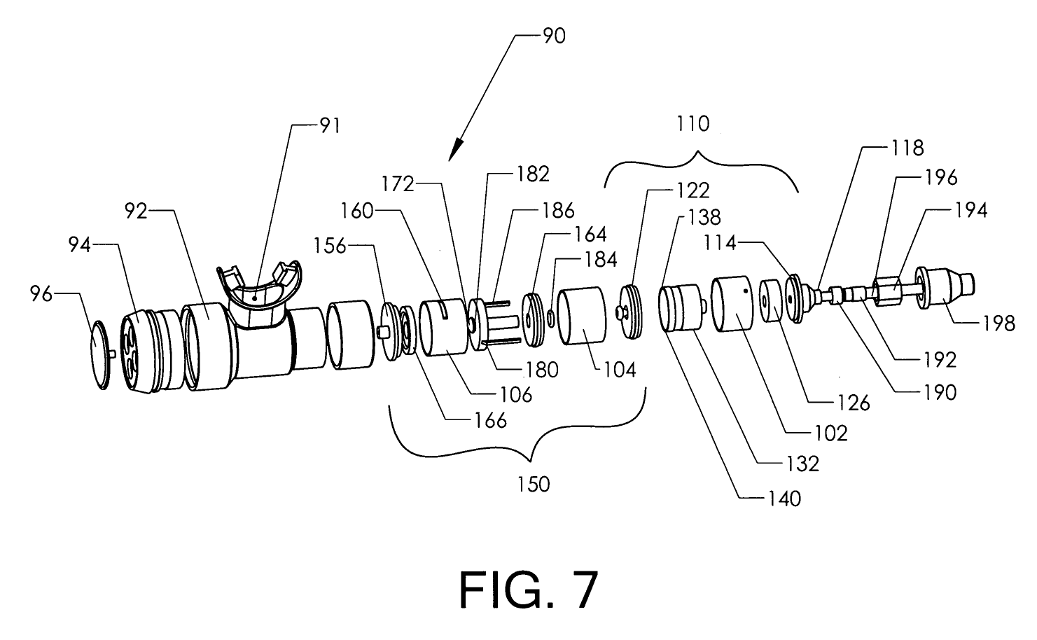

FIG. 5A is a perspective view and FIG. 5B an end view of a multistage regulator 90 constructed according to the teachings of the present disclosure suitable for use in a scuba application. Regulator 90 has a mouthpiece housing 92 for housing the various components which make up the multistage regulator 90. Regulator 90 has an exhaust cap 94 and a valve 96 (seen in FIGS. 6 and 7), the functions of which are described herein below.

Turning now to FIGS. 6 and 7, regulator 90 has a housing 100 constructed of an upstream portion 102, an intermediate portion 104, and a downstream portion 106. Housing 100 also has a first or upstream end cap 114 and a second or downstream end cap 156. Upstream end cap 114 has an ingress opening 118 adapted for connection to a source of gas at a first pressure. The downstream portion 106 of housing 100 has an egress opening 160 adapted for supplying gas at a lower pressure than the first pressure to a chamber 91 formed in the mouthpiece housing 92. A first fixed member 122 is located within housing 100 and separates ingress 118 from an intermediate chamber 142. A second fixed member 162 is located within housing and separates the intermediate chamber 142 from egress 160. Each of fixed members 122, 162 has at least one opening extending there through.

Those of ordinary skill in the art will recognize that the portion of regulator 90 between upstream end cap 114 and the first fixed member 122 is substantially similar to regulator 10 shown in FIG. 1A while the portion of regulator 90 between first fixed member 122 and end cap 156 is substantially similar to regulator 50 shown in FIG. 2A. The portion of regulator 90 between upstream end cap 114 and first fixed member 122 forms a first stage or upstream regulator 110 while the portion of regulator 90 between the first fixed member 122 and downstream end cap 156 forms a second stage or downstream regulator 150 as seen best in FIG. 7. The first stage regulator 110 may operate as discussed above in conjunction with FIG. 1A while the downstream or second stage regulator 150 may operate as discussed above in conjunction with FIG. 2A. However, regulator 90 need have only one of the first stage regulator 110 or the second stage regulator 150 constructed according to the teachings of the present invention to fall within the scope of this invention. In other words, first stage regulator 110 could be used in conjunction with a conventional second stage regulator (not shown) or second stage regulator 150 could be used in conjunction with a conventional first stage regulator (not shown). However, the maximum benefit is gained when both the first stage regulator 110 and the second stage regulator 150 are constructed according to the teachings of the present disclosure as illustrated in FIGS. 6 and 7.

It is seen from FIGS. 6 and 7 that regulator 90 has a first valve located within the first stage regulator 110 to control the flow of gas from ingress 118 to the intermediate chamber 142 and a second valve located within the second stage regulator 150 to control the flow of gas from the intermediate chamber 142 to egress 160. A compressible material is located within housing 100 such that at least one of the first and second valves is responsive to a force exerted by the compressible material when in one of either an opened or closed position.

More specifically, the valve in the first stage regulator 110 takes the form of a piston 132 positioned between the first fixed member 122 and a compressible member 126 to control the flow of gas from ingress 118 to the intermediate chamber 142. Piston 132 has a first face 134 carrying a seat 136. Piston 132 has a second, concaved face 138 juxtaposed with the first fixed member 122. Piston 132 is adapted for moving left to right between the first fixed member 122 and compressible material 126.

Downstream end of a first stage throttling tube 130 has a raised sharp edge. The concaved second face 138 of piston 132 is in communication with seat 136 through a plurality of channels 140. Downstream chamber 142 receives gas through openings 124 in fixed member 122.

The second stage regulator 150 has a compressible material 66 carried so as to be adjacent to downstream end cap 156. A valve seat 168 is carried on one surface of first fixed member 122.

A second stage throttling tube 170 is carried so as to extend through an opening 164 in second fixed member 162 to control the flow of gas from the intermediate chamber 142 to egress 160. The second stage throttling tube 170 has a downstream end 172 juxtaposed with disk 166, made up of a compressible material (also described in FIG. 3), and an upstream end 174 positioned so as to interact with valve seat 168. Throttling tube 170 may have openings 176 formed therein which lead to the chamber 91 in the interior of mouthpiece housing 92. Valve seat 168 may carry an O-ring 178 to seal off the upstream end 174 of throttling tube 170 from the source of gas available in intermediate chamber 142.

A sliding member 180 is circular in shape so as to be held within downstream housing portion 106. Sliding member 180 has a circular opening 182 there through for carrying downstream end 172 of second stage throttling tube 170. The upstream end 174 of the second stage throttling tube 170 is carried within opening 164 in second fixed member 62. A seal is formed between the second fixed member 162 and the second stage throttling tube 170 by an O-ring 184. Sliding member 180 is responsive to an actuation lever 186 as discussed above in conjunction with FIG. 2A.

Completing the description of regulator 90 shown in FIGS. 6 and 7, a hose connector 190 is provided to connect the first stage throttling tube 130 to upstream end cap 114. A hose crimp sleeve 192 and retaining nut 194 are used to maintain the connection between a high-pressure hose 196 and the first stage throttling tube 130. A sleeve fitting 198 may be provided to fit over the aforementioned components as well as a portion of upstream end cap 114 as shown in FIG. 6. Valve 96 attaches to the end of exhaust cap 94. Valve 96 allows excess air out of regulator 90 while preventing water from entering end of exhaust cap 94. Valve 96 is an exhaust or diffuser valve which is held in place by resistance and allows the user to blow out air while preventing water from entering regulator 90. In the preferred embodiment valve 96 is made of a porous material and arcs away from exhaust cap 94.

Several advantages flow from the compact construction illustrated in FIGS. 6 and 7. In addition to the benefits described above in connection with regulator 10 of FIG. 1A and regulator 50 of FIG. 2A, by combining both the first stage regulator 110 and second stage regulator 150 within the mouthpiece housing 92, both regulators may be kept warm by the user thereby preventing the first stage regulator 110 from freezing, which is possible in the prior art in which the first stage regulator 110 is located at a valve on the high-pressure tank. Thus, the first stage reduction is not performed until it reaches regulator 90 where both the first and second stage reductions are accomplished. Regulator 90 is substantially smaller in size and weight when compared to the current first and second stage regulators on the market today. In addition, the high-pressure hose 196 may be smaller in comparison to the hoses in use today. The result will be a less cumbersome, lighter weight, less obtrusive regulator/breathing apparatus 90.

Regulator 90 can be retrofitted into existing high-pressure tanks with the addition of one fixture. In other words, regulator 90 will be compatible with the current high-pressure cylinder sources currently in use. In addition, regulator 90 may be used in conjunction with higher pressure air systems using smaller tanks. For example, many diving applications have 6000 psi tanks of a certain size and volume. Regulator 90 of the present disclosure and micro-hose 196 can accommodate 10,000 psi thereby reducing the size of the tanks. Instead of having one large 6000 psi tank, regulator 90 will enable the user to use multiple small air bottles at a higher pressure, e.g. 10,000 psi. Thus, regulator 90 can be viewed as a substitute regulator compatible with current high-pressure tanks or a new air delivery system with both regulator and higher pressure, smaller, modular tank system.

The mouthpiece housing 92 of the present invention may be constructed of soft silicon in two stages. The mouthpiece may be made in a universal manner so as to be used in a right or left hand manner. A single touch can be used for purging. In the preferred embodiment, regulator 90 has two valves for purging the air from regulator 90. A user can grasp either valve, located on the top and bottom of the regulator, opening the air valve manually thereby releasing or purging the air from regulator 90. As previously mentioned, both the first stage regulator 110 and the second stage regulator 150 may be constructed by press fitting the components illustrated in FIG. 7 so that the entire assembly fits within mouthpiece housing 92.

A multistage regulator 90 of the type previously disclosed may be used in a variety of applications other than scuba applications. For example, firefighters, hazmat crews, or other types of first responders may benefit by having a contained breathing apparatus (tanks plus regulator) which is lighter in weight and less cumbersome to use. Other applications, such as pilots and the like, may require the use of a portable breathing apparatus for a short period of time, e.g. as a plane is rapidly descending. The present invention, because it can be pressurized to such a high-pressure level, can provide a breathing device having sufficient breathing time in an extremely small and compact manner which may be highly desirable in, for example, a fighter aircraft where space is at a premium.

While the present invention has been described in connection with preferred embodiments thereof, those of ordinary skill in the art will recognize that many modifications and variations are possible. The present invention is intended to be limited only by the following claims and not by the foregoing description which is intended to set forth the presently preferred embodiment.

What is claimed is:

1. A springless regulator, comprising:
(a) a housing having an ingress adapted for connection to a source of gas at a first pressure and an egress adapted for supplying gas at a lower pressure than said first pressure;
(b) a fixed member located within said housing and separating said ingress from said egress, said fixed member having at least one opening extending there through;
(c) a compressible material carried within said housing; and
(d) a valve located within said housing to control the flow of gas from said ingress to said egress, said valve being responsive to said compressible material such that said compressible material provides a force on said valve when said valve is in one of either an open position or a closed position.

2. The regulator of claim 1 wherein said compressible material is comprised of urethane foam.

3. The regulator of claim 1 wherein said compressible material is shaped into a disk having a plano-convex center, a thinner radial portion and a perimeter portion having a thicker cross-section than said thinner radial portion.

4. The regulator of claim 1 wherein said housing is comprised of at least two parts, and wherein said fixed member is one of press fit or welded at a joint between said two housing parts.

5. The regulator of claim 1 wherein said valve is one of a normally closed valve or a normally open valve.

6. The regulator of claim 1 additionally comprising a throttling tube extending through said ingress, and wherein said valve includes a piston having a first face carrying a seat, said piston adapted for moving said seat into and out of engagement with said throttling tube, said compressible material carried so as to be compressed when said seat engages said throttling tube.

7. The regulator of claim 6, wherein said piston has a concaved, second face opposite said first face and juxtaposed with said fixed member, said concaved face in communication with said seat through at least one channel extending through said piston.

8. The regulator of claim 1 wherein said valve includes a throttling tube carried within said housing and extending through said opening in said fixed member, one end of said housing carrying a seat, and wherein said valve includes a lever responsive to a pressure in said housing for moving said throttling tube into and out of engagement with said seat, said compressible material carried so as to be compressed when said throttling tube is out of engagement with said seat.

9. A springless regulator, comprising:
(a) a housing having an ingress adapted for connection to a source of gas at a first pressure and an egress adapted for supplying gas at a lower pressure than said first pressure;
(b) a fixed member located within said housing and separating said ingress from said egress, said fixed member having at least one opening extending therethrough;
(c) a compressible material carried at one end of said housing;
(d) a valve seat carried at an end of said housing opposite from said end carrying said compressible material;
(e) a throttling tube located in said housing and extending through said opening in said fixed member to control the flow of gas from said ingress to said egress, said throttling tube having a first end juxtaposed with said compressible material and a second end juxtaposed with said valve seat; and
(f) an actuation lever responsive to a pressure within said housing to move said throttling tube into and out of engagement with said valve seat, said throttling tube being responsive to a force provided by said compressible material when said throttling tube is out of engagement with said valve seat.

10. The regulator of claim 9 wherein said compressible material is comprised of urethane.

11. The regulator of claim 9 wherein said compressible material is shaped into a disk having a plano-convex center, a thinner radial portion and a perimeter portion having a thicker cross-section than said thinner radial portion.

12. The regulator of claim 9 wherein said housing is comprised of at least two parts, and wherein said fixed member is one of press fit or welded at a joint between said two housing parts.

13. A springless regulator, comprising:
(a) a housing having an ingress adapted for connection to a source of gas at a first pressure and an egress adapted for supplying gas at a lower pressure than said first pressure;
(b) a fixed member located within said housing and separating said ingress from said egress, said fixed member having at least one opening extending therethrough;
(c) a compressible material carried at one end of said housing and having an opening extending there through;
(d) a throttling tube extending through said ingress and said opening in said compressible material;
(e) a piston positioned between said fixed member and said compressible material to control the flow of gas from said ingress to said egress, said piston having a first face carrying a seat, said piston adapted for moving said seat into and out of engagement with said throttling tube, said compressible material carried so as to be compressed when said seat engages said throttling tube.

14. The regulator of claim 13 wherein said compressible material is comprised of urethane.

15. The regulator of claim 13 wherein said compressible material is shaped into a disk having a plano-convex center, a thinner radial portion and a perimeter portion having a thicker cross-section than said thinner radial portion.

16. The regulator of claim 13 wherein said housing is comprised of at least two parts, and wherein said fixed member is one of press fit or welded at a joint between said two housing parts.

17. The regulator of claim 13 wherein said piston has a concaved, second face opposite said first face and juxtaposed with said fixed member, said concaved face in communication with said seat through at least one channel extending through said piston.

18. The regulator of claim 13, wherein said fixed member separates said ingress from an intermediate chamber, and wherein a second fixed member located within said housing separates said intermediate chamber from said egress, said fixed members each having at least one opening extending there through.

19. The regulator of claim 13, further comprising a first valve located within said housing to control the flow of gas from said ingress to said intermediate chamber and a second valve located within said housing to control the flow of gas from said intermediate chamber to said egress.

20. The regulator of claim 13 wherein said first valve is one of a normally closed valve or a normally open valve and wherein said second valve is one of a normally closed valve or a normally open valve.

21. The regulator of claim 13 additionally comprising a throttling tube extending through said ingress, and wherein said first valve includes a piston having a first face carrying a seat, said piston adapted for moving said seat into and out of engagement with said throttling tube, said compressible material carried so as to be compressed when said seat engages said throttling tube.

22. The regulator of claim 13 wherein said piston has a concaved, second face opposite said first face and juxtaposed with said first fixed member, said concaved face in communication with said seat through at least one channel extending through said piston.

23. The regulator of claim 13 wherein said second valve includes a throttling tube carried within said housing and extending through said opening in said second fixed member, one face of said first fixed member carrying a seat, and wherein said valve includes a lever responsive to a pressure in said housing for moving said throttling tube into and out of engagement with said seat, said compressible material carried so as to be compressed when said throttling tube is out of engagement with said seat.

24. A springless regulator, comprising:
(a) a housing having an ingress adapted for connection to a source of gas at a first pressure and an egress adapted for supplying gas at a lower pressure than said first pressure;
(b) a first fixed member located within said housing and separating said ingress from an intermediate chamber, and a second fixed member located within said housing for separating said intermediate chamber from said egress, said fixed members each having at least one opening extending therethrough;
(c) a compressible material carried at one end of said housing; a valve seat carried on a face of said second fixed member opposite from said compressible material;
(d) a throttling tube located in said housing and extending through said opening in said second fixed member to control the flow of gas from said intermediate chamber to said egress, said throttling tube having a first end juxtaposed with said compressible material and a second end juxtaposed with said valve seat;
(e) an actuation lever responsive to a pressure within said housing to move said throttling tube into and out of engagement with said valve seat, said throttling tube being responsive to a force provided by said compressible material when said throttling tube is out of engagement with said valve seat; and a valve for controlling the flow of gas from said ingress to said intermediate chamber.

25. The regulator of claim 24 wherein said compressible material is comprised of urethane foam.

26. The regulator of claim 24 wherein said compressible material is shaped into a disk having a plano-convex center, a thinner radial portion and a perimeter portion having a thicker cross-section than said thinner radial portion.

27. The regulator of claim 24 wherein said housing is comprised of at least three parts, and wherein said fixed members are one of press fit or welded at a joint between said housing parts.

28. The regulator of claim 24, further comprising a piston positioned between said first fixed member and said compressible material to control the flow of gas from said ingress to said intermediate chamber, said piston having a first face carrying a seat, said piston adapted for moving said seat into and out of engagement with said throttling tube, said compressible material carried so as to be compressed when said seat engages said throttling tube; and
